(19) United States
(12) Patent Application Publication
(10) Pub. No.: US 2023/0116815 A1
(43) Pub. Date: Apr. 13, 2023

(54) DATA MANAGEMENT SYSTEM AND METHOD

(71) Applicant: LCR DYNAMICS LLC, Crossville, TN (US)

(72) Inventors: JOSEPH A SWIFT, Crossville, TN (US); Christian Heislop, Crossville, TN (US)

(73) Assignee: LCR DYNAMICS LLC, Crossville, TN (US)

(21) Appl. No.: 18/045,042

(22) Filed: Oct. 7, 2022

Related U.S. Application Data
(60) Provisional application No. 63/262,196, filed on Oct. 7, 2021.

(51) Int. Cl. G06F 16/28; G06F 16/25; G06F 16/23

(52) U.S. Cl. CPC G06F 16/285; G06F 16/258; G06F 16/2358

(57) ABSTRACT

A system for managing large volumes of complex data, having a node cluster having a data receiving node cluster having a plurality of integrated circuits, a computer readable storage medium having a computer program providing instructions to the plurality of integrated circuits, a plurality of data acquisition ports connected to a data acquisition device transmitting data to the plurality of integrated circuits, a plurality of data receiving ports, and a plurality of data transmitting ports; and a preprocessor having a processor, a computer readable storage medium having a computer program providing instructions to the processor, a plurality of data receiving ports connected to one of the plurality of data transmitting ports of the data receiving node, and a plurality of data transmitting ports connected to the plurality of data receiving port of the data receiving node and to a central processor.

### CROSS-REFERENCE

This Application claims the benefit of priority under 35 U.S.C. § 119(e) to U.S. Provisional Patent Application Ser. No. 63/262,196 filed Oct. 7, 2021, the contents of which are incorporated by reference herein as if set forth in their entirety for all purposes as if put forth in full below.

### BACKGROUND OF THE INVENTION

### Technical Field

The present invention relates to electronic data management technology. More particularly, the present invention relates to systems, computer program products, and methods for managing large volumes of complex data, where data may be from multiple sources, and where data types, formats, and standards may vary and change over time.

### Background Information

Scientific research uses increasingly more sophisticated lab equipment for monitoring experiments. Such equipment generates large volumes of data which must be stored and managed. The complexity increases as multiple equipment types may be used for a single experiment. Each piece of equipment may have its own data format, data type, and data structure. Thus, not only is data management an issue but so is coordination and combination to produce a meaningful output. Furthermore, as research environments are increasingly networked across different geographic locations, there is a need for managing shared data and producing data output acceptable to multiple parties, while keeping data access secure.

For long-term experiments, data management is complicated by immense data volumes, equipment updates, data formats changes, and potential data type changes. This illustrates the challenge posed within a single experiment. The challenge to the research communities increases when multiple experiments may require coordination as part of large-scale research.

Outside of scientific research, data accumulation and data management are increasingly becoming a challenge. Businesses and manufacturers, governments, and researchers in all sectors are spending a significant amount of time wading through raw data from multiple sources in multiple formats and trying to find ways of managing it. This leads to situations where vast amounts of data may be ignored simply because it is not in a format to allow for analysis, or because data stores were created in isolation from others due to the lack of data commonality.

There is also a growing amount of complex and unstructured data, stored in data bases and in various cloud environments, that is under-utilized and represents a vast value-add potential.

The present invention addresses the need for managing large volumes of data, locating and identifying data sources, finding commonality between different data types, formats, standards, and structures, and to make such data securely available in a useful format.

### SUMMARY OF THE INVENTION

The shortcomings of the prior art are overcome, and additional advantages are provided, through the provision of the present disclosure directed towards systems, computer program products, and methods for managing large volumes of complex data, where data may be from multiple sources, and where data types, formats, and standards may vary and change over time.

In one aspect of the present disclosure provided herein, is a system for managing large volumes of complex data, having a node cluster and a preprocessor. The node cluster has a data receiving node cluster having a plurality of integrated circuits, a computer readable storage medium having a computer program providing instructions to the plurality of integrated circuits, a plurality of data acquisition ports with at least one connected to a data acquisition device transmitting data to the plurality of integrated circuits, a plurality of data receiving ports, and a plurality of data transmitting ports. The preprocessor has a processor, a computer readable storage medium having a computer program providing instructions to the processor, a plurality of data receiving ports with at least one of the plurality of data receiving ports connected to at least one of the plurality of data transmitting ports of the data receiving node, and a plurality of data transmitting ports with at least one of the plurality of data transmitting ports connected to at least one of the plurality of data receiving port of the data receiving node and at least one of the plurality of data transmitting ports connected to a central processor. Data acquired by the data acquisition devices is received by the plurality of integrated circuits, categorized, logged in a log file, and the log file transmitted to the preprocessor. The preprocessor receives the log file and transmits a request for data, based on the log file, to the plurality of integrated circuits, and categorized data is received by the preprocessors. Data is translated by the preprocessor and the translated data is transmitted to the central processor.

In another aspect of the present disclosure provided herein, is a computer implemented method including acquiring, by a data acquisition apparatus having at least one processor, data from at least one data source; transmitting data to at least one node cluster having a master node connected to a plurality of nodes, the master node having at least one processor and the plurality of nodes each having at least one processor; receiving, by at least one processor, data in one of the plurality of nodes; storing data in a file type based on preset parameters and correlated with the data received; logging data information in a log file, the data information including data storage information, the data file type, and data file information association; organizing, by the processor of the master node, contents of the log file; determining, by the processor of the master node, a relevance of the log file contents and the stored data, the relevance based on parameters; adjusting, by the processors of the master node, the parameters; sending, by the processors of the master node, the log file information and the data storage information to a preprocessor comprising at least one processor; translating, by the at least one processor of the preprocessor, received data; matching, by the at least one processor of the preprocessor, file types to the data file information association; organizing, by the at least one processor of the preprocessor, translated data; transmitting, by the at least one processor of the preprocessor, translated data; receiving translated data, by at least one processor of a central processing node, the central processing node further comprising a memory, and data storage; converting, by the at least one processor or the central processing node, translated data into a final output data.

In another aspect of the present disclosure provided herein, is a system having a plurality of computers each having a memory and one or more processor in communications with the memory; program instructions executable by the one or more processors via the memory to perform a method, the method including the system configured to perform a method, the method including a computer-implemented method including: acquiring, by a data acquisition apparatus having at least one processor, data from at least one data source; transmitting data to at least one node cluster having a master node connected to a plurality of nodes, the master node having at least one processor and the plurality of nodes each having at least one processor; receiving, by at least one processor, data in one of the plurality of nodes; storing data in a file type based on preset parameters and correlated with the data received; logging data information, data storage information, the data file type, and data file information association in a log file; organizing, by the master node, contents of the log file; determining, by the master node, relevance of the log file contents and the stored data, the relevance based on parameters adjusted by the master node; sending the log file information and the data storage information to a preprocessor, the preprocessor having at least one processor; translating, by the preprocessor, received data so that the file types match the data file information association; organizing, by the preprocessor, translated data; transmitting, by the preprocessor, translated data; receiving, by a central processing node, translated data, the central processing node having at least one processor, memory, and storage; converting, by the central processing node, translated data into a final output data.

In another aspect of the present disclosure provided herein, is a computer program product including a computer readable storage medium readable by one or more processors and storing instructions for execution by one or more processors for performing a method including computer implemented method including, acquiring, by a data acquisition apparatus having at least one processor, data from at least one data source; transmitting data to at least one node cluster having a master node connected to a plurality of nodes, the master node having at least one processor and the plurality of nodes each having at least one processor; receiving, by at least one processor, data in one of the plurality of nodes; storing data in a file type based on preset parameters and correlated with the data received; logging data information, data storage information, the data file type, and data file information association in a log file; organizing, by the master node, contents of the log file; determining, by the master node, relevance of the log file contents and the stored data, the relevance based on parameters adjusted by the master node; sending the log file information and the data storage information to a preprocessor, the preprocessor having at least one processor; translating, by the preprocessor, received data so that the file types match the data file information association; organizing, by the preprocessor, translated data; transmitting, by the preprocessor, translated data; receiving, by a central processing node, translated data, the central processing node having at least one processor, memory, and storage; converting, by the central processing node, translated data into a final output data.

In another aspect of the present disclosure provided herein, is a data preprocessing system having a readable storage medium readable by one or more data preprocessors and storing instructions for execution by one or more preprocessors for performing a method including a combination of hardware and software implemented method including, acquiring, by a data acquisition apparatus in communication with at least one preprocessor, data from at least one data source; transmitting data to at least one node cluster element of the preprocessor having a master node connected to a plurality of secondary nodes, the master node having at least one data preprocessor element and the plurality of nodes each having at least one preprocessor element; receiving, by at least one preprocessor, data in one of the plurality of nodes; storing data in a file type based on preset parameters and correlated with the data received; logging data information, data storage information, the data file type, and data file information association in a log file; organizing, by the preprocessing master node, contents of the log file; determining, by the master node, relevance of the log file contents and the stored data, the relevance based on parameters adjusted by the master node; sending the log file information and the data storage information to a preprocessor, the preprocessor having at least one software computer program capable of; translating, by the preprocessor, received data so that the file types match the data file information association; organizing, by the preprocessor, translated data; transmitting, by the preprocessor, translated data; receiving, by a central processor, translated data, the central processor having at least one processor, memory, and storage; converting, by the central processor, translated data into a final output data.

In another aspect of the present disclosure provided herein, is a method of processing data using a preprocessor including: receiving and prescreening incoming data, characterizing the data, routing the data to a database, consolidating the data into predesignated formats, transposing the data, characterizing the degree of transposition and consolidation, recording processing time, directing output data to an assigned storage, using the data output as a feedback loop to enable continued processing, calculating and compiling a metadata stream, adjusting a preprocessor control program to promote precision and efficiency; configuring an output data stream, and transmitting an output data stream.

These and other objects, features, and advantages of this disclosure will become apparent from the following detailed description of the various aspects of the disclosure taken in conjunction with the accompanying drawings.

### BRIEF DESCRIPTION OF THE DRAWINGS

FIG. 1, depicts a block diagram of a conventional data management system;

FIG. 2, depicts a block diagram of a data management system, in accordance with one or more embodiments set forth herein;

FIG. 3A, depict block diagrams of the node cluster and pre-processor interface of the data management system of FIG. 2, in accordance with one or more embodiments set forth herein;

FIG. 3B, depicts the node cluster of FIG. 2, in accordance with one or more embodiments set forth herein;

FIG. 3C, depicted the preprocessor of FIG. 2, in accordance with one or more embodiments set forth herein;

FIG. 4, depicts a further block diagram of the data management system of FIG. 2, in accordance with one or more embodiments set forth herein;

FIG. 5, is a data acquisition apparatus, in accordance with one or more embodiments set forth herein;

FIG. 6, is a data acquisition apparatus and node cluster, in accordance with one or more embodiments set forth herein;

FIG. 7, depicts a flow chart of preprocessor operation, in accordance with one or more embodiments set forth herein;

FIG. 8, is an illustrative graphic example of an output from data processing, in accordance with one or more embodiments set forth herein; and

FIG. 9, depicts an extended block diagram of a modified data management system of FIG. 2, in accordance with one or more embodiments set forth herein.

### DETAILED DESCRIPTION OF THE INVENTION

Aspects of the present disclosure and certain embodiments, features, advantages, and details thereof, are explained more fully below with reference to the non-limiting examples illustrated in the accompanying drawings. However, it should be understood that the detailed description and the specific examples, indicate aspects of the disclosure for illustration and not for limitation. Substitutions, modifications, additions, and/or arrangements fall within the spirit and/or scope of the underlying inventive concepts and from this disclosure will be apparent to those skilled in the art. Furthermore, although certain methods are described herein with reference to certain steps presented in a certain order, one skilled in the art may appreciate that these steps may be performed in any order in many instances. Thus, the methods described are not limited to the particular arrangement of steps disclosed herein.

Approximating language, as used throughout this disclosure, may be applied to modify any quantitative representation that could permissibly vary without resulting in a change in the basic function to which it is related. Accordingly, a value modified by a term or terms, such as “about” or “substantially,” is not limited to the precise value specified. In some instances, the approximating language may correspond to the precision of an instrument for measuring the value.

Terminology used is for the purpose of describing particular examples only and is not intended to be limiting. The use of singular forms “a”, “an” and “the” are intended to include the plural forms as well, unless the context clearly indicates otherwise. Furthermore, references to “one embodiment” are not intended to be interpreted as excluding the existence of additional embodiments that also incorporate the recited features. Moreover, unless explicitly stated to the contrary, the terms “comprising” (and any form of “comprise”), “have” (and any form of “have”), “include” (and any form of “include”), and “contain” (and any form of “contain”) are used as open-ended linking verbs. As a result, any embodiments that “comprises,” “has,” “includes” or “contains” the presence of stated features, integers, steps, operations, elements, and/or components, but do not preclude the presence or addition of one or more other features, integers, steps, operations, elements, components and/or groups thereof. As used herein, the terms “may” and “may be” indicate a probability of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while in some circumstances the modified term may sometimes not be appropriate, capable, or suitable. For example, in some circumstances, an event or capacity can be expected, while in other circumstances the event or capacity cannot occur—this distinction is captured by the terms “may” and “may be.”

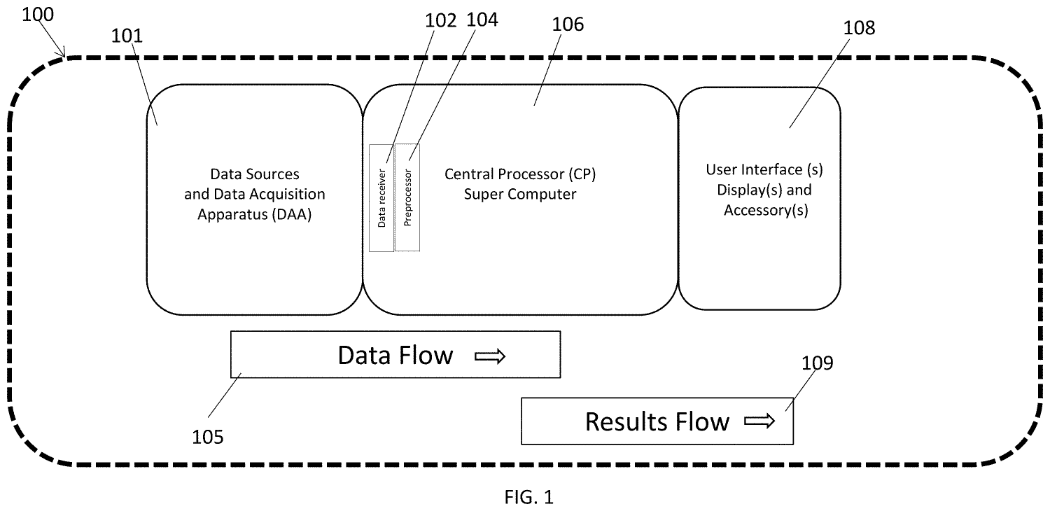

The invention herein will be better understood by reference to the figures where like reference numbers refer to like components. Referring to the drawings, where like reference numerals are used to indicate like or analogous components throughout the several views. With reference to FIG. 1, a conventional data management system 100 is depicted as an example of the current art and to provide an explanation of the improvements provided by the embodiments of the invention described herein. The conventional data management system 100 may be one or more data acquisition apparatuses 101, connected to a central processor 106, connected to a user interface and/or accessories 108. The central processor 106 generally has a data receiver 102, and some may include a preprocessor 104. The data receiver 102 and, if included, the preprocessor 104 are within the central processor. The central processor 106, user interface and local accessories 108 may be, for example, electrically connected to transfer data and computational results from input at the data acquisition apparatus 101 through the central processor 106 and to output at the use interface and/or accessories 108. Thus, data flow 105 and computational results flow 109 proceed in a single direction. In a conventional data management system 100, the flow of data 105 is linear as it originates at the data acquisition apparatus 101 and arrives at the central processor 106 where a program provides instructions to the central processor to calculate results 109 and send them to a user interface 108. There may be continuous data streams 105 and continuous streams of results 109 which flow linearly from the central processor 106 to the user interface 108.

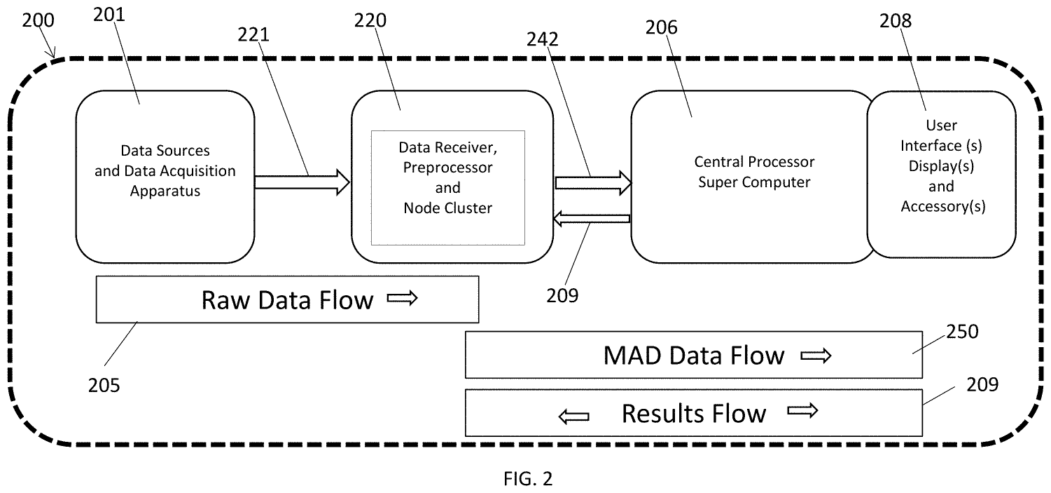

FIG. 2 illustrates an embodiment of a data management system 200 having a data acquisition apparatus (DAA) 201, a node cluster 220, a central processor 206, and an input/output device 208. The user input/output device 208 may be at least one input device and/or at least one output device and/or at least one interface accessory. The DAA 201 may be a single device or a plurality of devices for monitoring, measuring, or gathering data and providing an output in an analog or digital format. Such devices may include but not be limited to, for example, image cameras, video cameras, microphones, radio frequency monitors, devices for monitoring frequencies within the electromagnetic spectrum, scales, temperature monitors, or any device gathering data and transmitting that data to another electronic device. Furthermore, both analog and digital devices may be included in the DAA 201.

The node cluster 220 may include a data receiver and a preprocessor, within the node cluster 220, forming a single assembly. The node cluster 220 and the DAA 201 may have a direct interconnection 221 through which data from the DAA 201 is transmitted to the node cluster 220. The node cluster 220 and the central processor 206 may have a first connection 242 through which data from node cluster 220 is transmitted to the central processor 206 and a second connection 209 through which data from the central processor 206 may be transmitted to the node cluster 220. The data interconnection 221, the first connection 242, and the second connection 209 may be a wire or a cable or a wireless transmission, through which data and/or electrical signals may be transmitted. While the data interconnection 221, the first connection 242, and the second connection 209 are depicted as a single data transmission path, there may be embodiments of the data management system 200, where there is a plurality of the data interconnection 221, and/or a plurality of first connection 242, and/or a plurality of second connection 209. In addition, there may be one, or more electrical connections to provide electrical power to the DAA 201, the node cluster 220, the central processor 206 and the user interface 208. The node cluster 220 may be configured to contain programmed instructions to act as a task-specific unit.

With continued reference to FIG. 2, the direction of raw data stream flow 205 is shown. The raw data stream may include multimodal data. As shown, the raw data stream is provided by the DAA 201 and flows along interconnection 221 towards the node cluster 220. Within the node cluster a multifunctional preprocessor is configured with hardware and instructed by programmed software to screen and validate incoming raw data and then to combine and configure the data into a modified data stream or more specifically, a machine augmented data stream (MAD). MAD flows in a direction 250 from the node cluster 220 to arrive at a central processor 206 via interconnect 242.

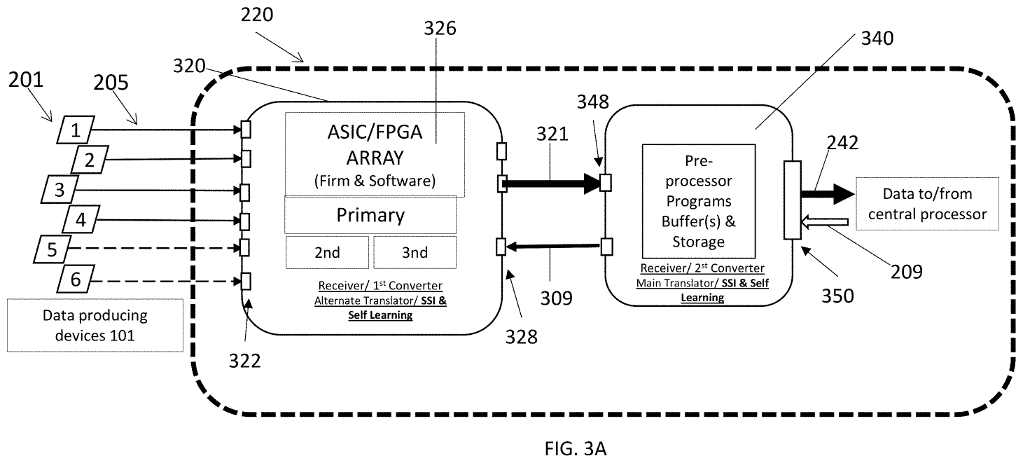

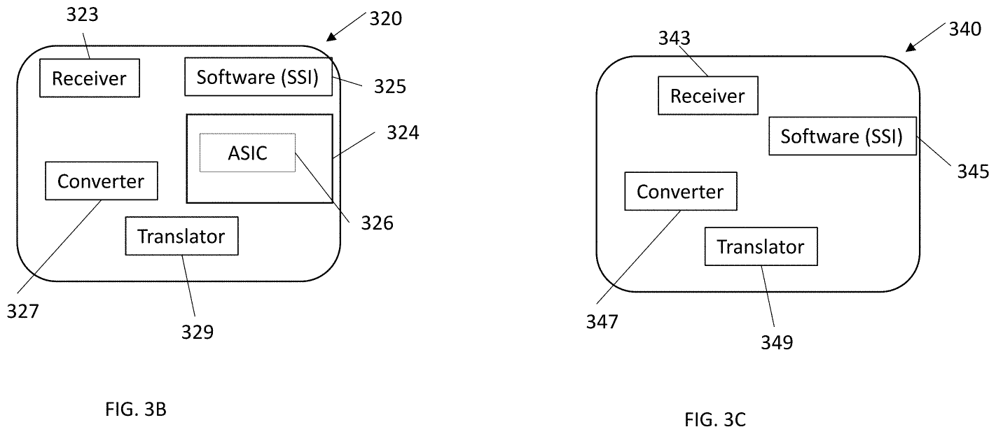

With reference to FIG. 3A, an embodiment of the node cluster apparatus 220 as a single unit is shown having a data receiving node cluster 320 and a preprocessor 340 within. Multiple data streams 205 are depicted as raw data stream 1, raw data stream 2, raw data stream 3, raw data stream 4, raw data stream 5, and raw data stream 6. The multiple raw data streams 205 may be from data sources 201, and the data sources may be a single device or from multiple devices having a data communication connection to the node cluster 220. Raw data may be data that is direct from the data source with no processing between capture or collection and storage or transmission. The data communication connection from the data source (e.g., DAA 201 in FIG. 2) to the data receiving node cluster 320 may, for example, be a direct connection or a networked connection or a combination of direct and networked connections. With reference to FIG. 3A, the data receiving node cluster 320, also referred to as a data receiving and preprocessing node cluster. is depicted as having a plurality of data receiving ports 322, through which data may be received by the data receiving node cluster 320. While 6 data streams are depicted, there may be more or less than 6 data streams. While 6 data ports 322 are depicted, there may be more or less than 6 data ports. The data receiving node cluster 320 has a plurality of application specific integrated circuits (ASICs) 326 with at least one directed by a node cluster software, providing instructions for screening incoming raw data, selecting data, validating data, configuring and/or re-configuring data, and transferring data from incoming multimodal raw data streams into a preprocessing element 340. The preprocessor 340 may, for example, convert the data streams into a common stream of MAD. MAD data may be raw data that has been altered in some manner by the preprocessor 340 to align the data transmitted by the preprocessor 340 through the output data stream 242 to accommodate the input requirements of the central processor 206 and improve the efficiency of the central processor 206.

An example of MAD may relate to calendar dates and times. There are more than 350 worldwide time-date formats in general use. Some are alphanumeric, some are numeric, some use separating slashes or dashes, some use separating dots. The preprocessor 340 may use a standard derived date format such as, for example, the ISO 8601 format YYYY-MM-DD (2022-08-30) to harmonize the format, for storage and subsequent organization, into a single framework and to promote a high degree of accuracy. Thus, in one of its operations, the preprocessor characterizes all date and format constructs provided and transposes each into the ISO format. This transposed data may be employed as a component of the MAD stream to promote efficient downstream program instructed processing and data storage operations. The MAD stream is constructed with contents and data formats that are optimized for central processing.

The multimodal data stream may describe a continuous flow of mixed data such as, for example, unformatted digitized data elements, mixed formatted data (e.g., alpha-character and numeric-alpha containing formats), foreign language alpha characters, poorly structured elements (e.g., matrices having different formats and sizes), and then like.

The plurality of ASICs 326 may be placed within an ASIC Array 324. In an alternate embodiment, field programmable gate arrays FPGA may be used within the node cluster as a replacement for one or more of the ASICs or for use in combinations with one or ASICS to accommodate the complexity and volumes of a variety of data configurations and to promote data preprocessing efficiency.

The data receiving node cluster 320 has data exchange ports 328 and preprocessor 340 has data exchange ports 348, with data interconnect 321 and data interconnect 309 connecting the data exchange ports 328 and data exchange ports 348. The data interconnect 321 may send or stream data, such as multimodal data, via data exchange ports 328 from the data receiving node cluster 320 to the preprocessor 340 via data exchange ports 348. The data interconnect 309 may send or stream data via data exchange ports 348 from the preprocessor 340 to the data receiving node cluster 320 via data exchange ports 328. Data interconnect 321 is shown as a single data communication path, however data interconnect 321 may be a plurality of data communication paths. Data interconnect 309 is shown as a single data communication path, however data interconnect 309 may be a plurality of data communication paths. The data interconnect 321 and the data interconnect 309 may be a wire or cable or a wireless transmission, through which data and/or electrical signals may be transmitted. The data exchange ports 328, the data exchange ports 348, the data interconnect 221, and data interconnect 209 may be designed to accommodate one way or two-way data flow.

The preprocessor 340 may have a data exchange port 350, which may be in communication connection with the central processor (e.g., the central processor 206 of FIG. 2).

With reference to FIG. 3B, the data receiving node cluster 320 is shown having a receiver 323, a converter 327, and control software 325 providing instructions to the data receiving node cluster 320 to serve as a data translator 329. In certain embodiments, the data receiving node cluster 320 may have one receiver, and one converter for each of the plurality of raw data stream 205 (e.g., raw data stream 1, raw data stream 2, raw data stream 3, raw data stream 4, raw data stream 5, and raw data stream 6). In certain other embodiments, one receiver and once converter may handle all of the incoming raw data streams 205. Depending on the complexity of each incoming stream it may be optimum to either combine or separate all of these. The control software 325 may be, for example, a specialized synthetic intelligence (SSI) system, a machine learning program, an artificial intelligence software or a similar learning software.

With reference to FIG. 3C, the preprocessor 340 may be configured to serve as a front-end translator apparatus 349, having a receiver 343, a converter 347, a main translator 349, and control software 345, such as, for example, a specialized synthetic intelligence form of AI.

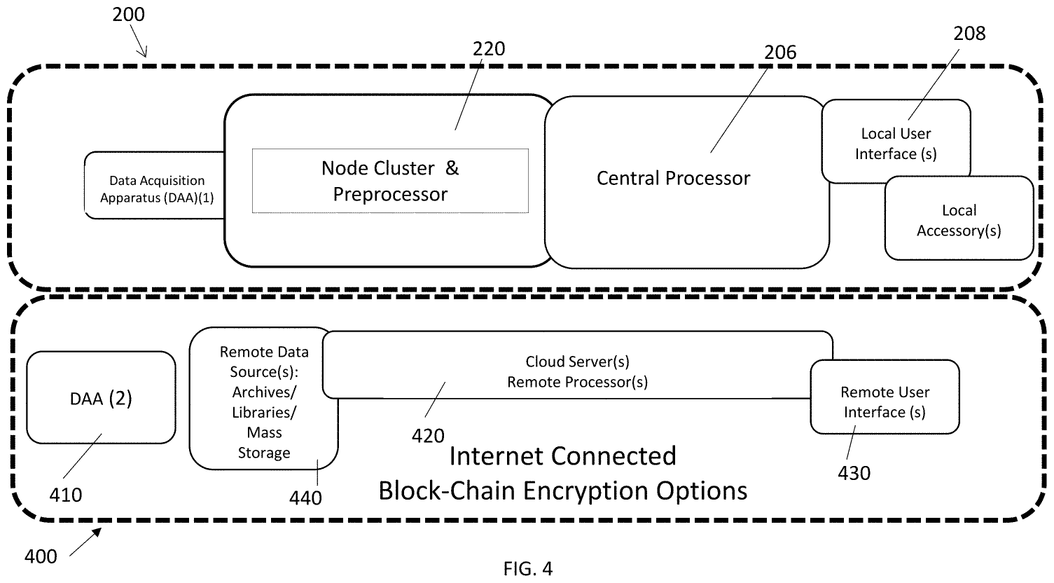

With reference to FIGS. 3A-3C, multiple data streams 205 (e.g., data stream 1, data stream 2, data stream 3, data stream 4, data stream 5, and data stream 6) represent raw data streams from a DAA 201 providing a plurality of data streams or a plurality of data acquisition apparatuses (e.g., a plurality of DAA 201) each providing a stream of data. The multiple data streams are received by the data receiving node cluster 220. The data streams 205 are screened, analyzed, and categorized by a combination of custom and open software configured to perform these operations. Data may be selected using a computer program providing instructions configured to match characteristics of the raw data to predefined norms stored in an archive that is accessible to the data receiving node 320 and/or the preprocessor 340. Data matching the norm may be acted upon. Data not matching the norm may be machine altered (MAD) to match a predefined format or structure and if the data cannot be successfully reformatted it may be rejected from further processing. The selected data may be validated by an extension of this computer program, which may provide instructions to validate data based on whether the data matches the norm or if not, whether the data may be machine altered to match the norm or rejected. The selected data may be reconfigured by the computer program that serves multiple objectives. The software program may translate all or some of the data into a form that when streamed to the central processor (e.g., central processor 206) removes the need for the central processor to do data preprocessing which may free the processing of the central processor to perform task-specific functions with great efficiency. The data may thus be transferred by interconnection 221 via the data ports 328, data ports 348, and data ports 350, and interconnect 321 and interconnect 309 to the preprocessor 340 for further processing. The preprocessor may receive the data, employ at least one SSI computer program to analyze and convert the data into a more useful processing format. The combination of at least one ASIC 324 and/or at least one multiple FPGAs using instructions from the program imbedded in each may be used to translate and reconfigure the data and transmit the transformed data to the central processor node 206. Data may be returned 309 to the node cluster 220 by the preprocessor 340 for further processing before being sent back to the preprocessor 340. Data may be transferred between node cluster 220 and the preprocessor 340 several times until the data is in a suitable condition to move to the center processor. The preprocessor 340 may conduct analytics, direct storage/archiving/transmitting operations, and display and/or export user-selectable outputs via an external connection 242 to the central processor 206, to a cloud server 420 (see FIG. 4), or directly to a user interface and display 208.

With reference to FIG. 4, the block diagram of the data management system 200 of FIG. 2 is show next to a block diagram of a cloud-based data management system 400 and interconnected via communication links (not shown). Some or all of the data acquisition apparatuses 201, 410 may alternatively be configured to send data to a remote data source that has at least one archive or library or mass storage for receiving and storing data from each of the data acquisition apparatuses 201, 410. The cloud server 420 may, for example, house the data receiving node cluster (e.g., data receiving node cluster 220) and preprocessor translator/converter (e.g., preprocessor 340) and optionally the central processor (e.g., central processor 206), with output data being sent to a remote user interface 430. In an alternate embodiment, the output data may be sent to a local user interface (e.g., local user interface 208) connected to the cloud server 420 or data may be sent to both the local user interface 208 and the remote user interface 430. In an alternate embodiment, the data receiving node cluster (e.g., data receiving node cluster 320) and preprocessor translator/converter (e.g., preprocessor 340) may be housed together to form a single unit (e.g., node cluster 220).

The data processing within the data management system 200 includes: receiving, by the data receiving node cluster (e.g., node cluster 220), data streamed from an internal or an external source (i.e., device or instrument) that produces a data output. The data receiving node cluster (e.g., node cluster 220) may receive translate, and/or integrate the received data. The data may then be transmitted for processing by the preprocessor (e.g., preprocessor 340) and a central processing node (e.g., central processor 206) before being transmitted from the cloud server 420 to a user on a remote interface 430.

With reference to FIGS. 3A-4, a block diagram of an integrated data management system (DMS) 400 is depicted. DMS 400 has a data acquisition apparatus (DAA) 410, which may be in the form of a camera module (not shown) having at least one high resolution digital camera, at least one lens, at least one application specific integrated circuit (ASIC) or at least one FPGA, and at least one data interface. The camera module may be integrated into a self-contained assembly having a data interface having an interconnection 205 that provides data streaming from the camera module to the data management system 400. The components of the DAA 410 depicted are provided for illustration, however any data gathering device may be included in the DAA 410 such as, for example, at least one device configured for monitoring, measuring, or gathering data and providing an output in an analog or digital format. Such devices may include but not be limited to, for example, image cameras, video cameras, microphones, radio frequency monitors, devices for monitoring frequencies within the electromagnetic spectrum, scales, temperature monitors, and the like. Furthermore, both analog and digital devices may be included in the DAA 410. While a single DAA 410 is shown, there may be a plurality of DAA devices 410 gathering and providing data for DMS 400.

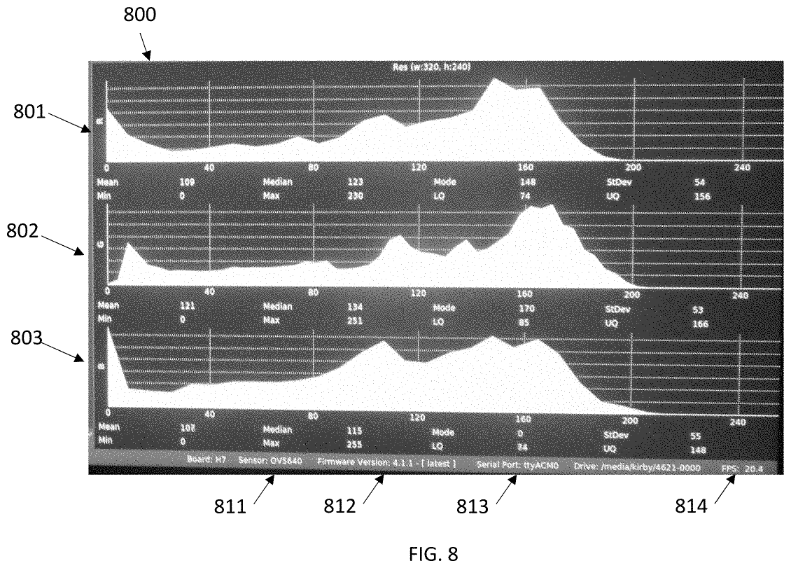

As an example of how analog data may be produced and may be used is illustrated by a color spectrum such as that shown in FIG. 8, where raw data is generated by an instrument such as an infrared spectrometer. Raw data generated by at least one DAA 410 is streamed to and acquired by a data management system 200 in an analog format wherein a computer program provided as an imbedded software package provides instructions to convert the analog data into a digital data counterpart. The digital data that has been converted in this process may be referred to as machine augmented data 250 which is in a format configured to optimize the performance of the CP 206. By allocating the preliminary data acquisition and data preprocessing operations to the data receiver/preprocessor/node cluster apparatus (e.g., node cluster 220), the efficiency of the entire data management system 200 may be optimized.

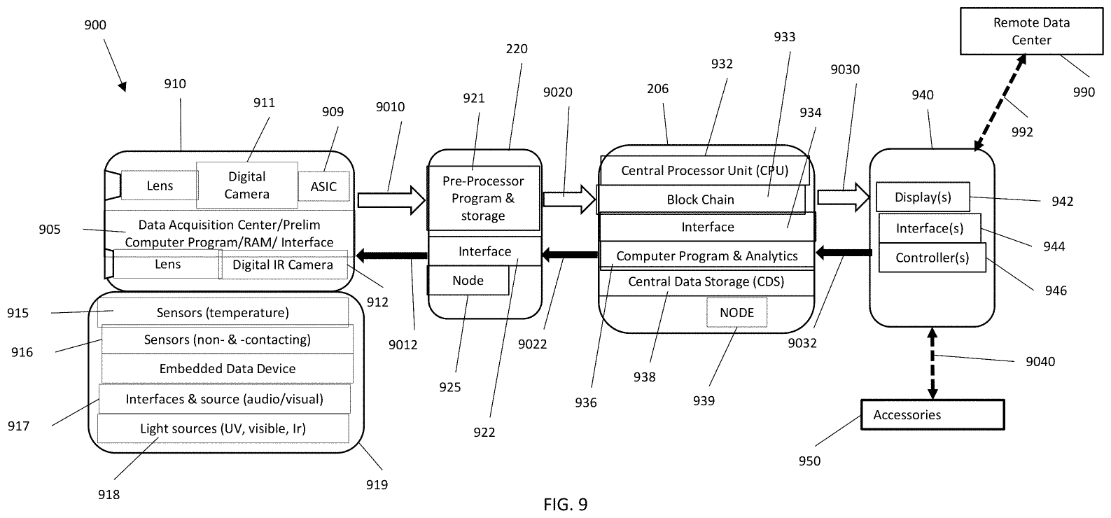

The embodiment of a data management system 900 as shown in FIG. 9 depicts a specific-purpose DAA 910 having imaging and biotelemetry devices such as a digital camera system 911 and a thermal camera system 912. The digital camera 911 and thermal camera 912 are connected to or have signal communication and/or electrical interconnections with a data preprocessor (e.g., preprocessor 340). The data preprocessor may have a storage media with a data preprocessor software program 921, a data interface 922, and at least one data node 925. The data preprocessor (e.g., preprocessor 340) may be connected to or have signal and/or electrical communication with a central processing node 206. The central processing node may have a processor unit 932, a central data storage 938, at least one data node 939, and an inter-module interface 934. At least one (ASIC) 909 may be disposed within the DAA 910 and electrically connected to the digital camera sub-system 911. The at least one data node 925 may be operatively disposed in the data preprocessor (e.g., preprocessor 340). In addition, at least one data node 939 may be operatively disposed in the central processing node 206. At least one block-chain protocol 933 may be included with the central processing node 206. At least one block-chain protocol may be included within the preprocessing node 925. A system controller unit (SCU) 932 may be in communication connection with the central processing node 939, a block chain security protocol 933, at least one computer program 936, a central storage unit 938 and an interface 934. The central processing node 206 may include at least one digital display unit 942 connected to and in electrical and/or signal communication with the central processor node 206.

DAA 910 may be connected to or be in communication with a sensor subsystem 919, which may include, for example, a temperature sensor 915, a detector 916, an audio source or receiver 917, and/or a light source 918 configured to function within at least in one part of the electromagnetic energy spectrum such as a narrow spectral region and an ultraviolet (UV) region. The components of sensor subsystem 919 are provided for illustration, however any data gathering device may be included in the DAA 910 such as, for example, at least one device configured for monitoring, measuring, or gathering data and providing an output in an analog or digital format. Such devices may include but not be limited to, for example, image cameras, video cameras, microphones, radio frequency monitors, devices for monitoring frequencies within the electromagnetic spectrum, scales, temperature monitors, and the like.

At least one encoded linkage 992 may connect the DMS system 900 with a remote data center 990 (e.g., the “cloud” and related “cloud computing” see also 420 of FIG. 4). As a further option, at least one system interface 944 or external electromechanical device 950 may be operatively connected to the at least one digital display 942. The DMS system 900 may include one or more of a set of interconnecting wires, cables, fiber optics, radio frequency (RF) receiver(s), RF transceivers, peripheral component interconnect (PCI), network cards, combinations, or the like which are not shown but may be used to physically, electrically, and/or provide signal connection between the DAA 910, the sensor subsystem 919, the preprocessor 920, the central processing node 206, accessories 950, and the remote data center 990.

In one embodiment, the DMS system 900 may be configured alternatively as four modules or “subsystems” (i.e., DAA 910, data preprocessor (e.g., preprocessor 340), central processing node 206, and outputs 940) with each subsystem having communication with at least one other subsystem. Electrical communication includes electrically connected and non-electrically connected: where electrically connected means components communicate with each other by means of a direct-conducting path such as through a wire, a cable, other conductors, circuitry, combinations, and the like; and non-electrically connected means components communicate with each other with or without a conducting path such as with radio signals, lasers, cellular or other telephones, WIFI (wireless fidelity) or other wireless network protocols, satellites, combinations, and the like. Components with electrical communication may be both electrically connected and non-electrically connected; for example, components may be electrically connected to supply electrical power and non-electrically connected via signal transfer means to transfer data and operating signals. Electrical communication may also include components such as data ports 328 and data ports 348 operatively connected by suitable data cables (e.g., interconnect 221, interconnect 309, interconnect 242, interconnect 209, interconnect 9010, interconnect 9012, interconnect 9020, interconnect 9022, interconnect 9030, interconnect 9032 to provide exchange of streams of raw and machine augmented data and results generated by the computer program operating between and controlling the above cited subsystems.

The node cluster apparatus 220 may include a preprocessing program and data storage 921 to receive data from the DAA 910 via an appropriately configured interface 905 and interconnection 9010 and then the preprocessor (e.g., the preprocessor 340 of FIG. 3A) via use of a specific interface 922 may be integrated together with a specific, programmed processor (e.g., programmed with SSI functions) along with machine learning (ML) computer program functions to calculate, compare, and contrast the incoming raw data against preprogrammed specifications, norms, and protocols that may be stored locally within preprocessor (e.g., preprocessor 340). While a simple program can be used, ML is preferred in a high-performance data management system because ML can derive and capture knowledge from and make comparisons among a large number of previously performed computer program operations. From this, ML and can track, calculate, and extract trends and or anomalies and then make periodic updates to the preprogrammed specifications, norms, and protocols and provides the records storage function to become a living-achieve/storage. ML instructs the preprocessing function to self-adjust and self-improve over time thereby minimizing future errors while optimizing operational performance. Within data preprocessor (e.g., preprocessor 340) may be a provision to store selected data as prescribed by one, or more computer programs. Then, at the same time, the data preprocessor serves to segregate portions of the incoming raw data from otherwise routine data and then executes at least one second analytical processing when a data element has been determined to fall short of meeting pre-established specifications. The subset of segregated data may be appropriately formatted and passed directly on via at least one data interface 922 and interconnection 9020 and interconnection 9030 to the at least one suitable display 942 or other data output accessory 950.

With reference to FIG. 2 and to FIG. 9 where the node cluster apparatus 220 is depicted as a subsystem which may be integrated into a data management system 200 thereby serving to offload any need to perform raw data management operations from the central processer 206.

Referring to FIG. 2, FIG. 3A-3C, and to FIG. 9, the node cluster 220, the raw data receiver 320, the preprocessor 340, and the at least one data node 925 may be deployed with components such as PCI express add on cards such as, but not limited to, the PCI Express Host Adapter card (not shown) sold by Allied Visio®. The ASIC devices (e.g., ASIC 326) used within an ASIC array 324 can include, but are not limited to, NVidia® Jetson platform with breakout board attachments including Jetson Nano, Jetson Xavier, and the likes. The ASIC device also can include, but not limited to, NVidia® GPU modules including RTX series, Quadro, DPU, and Tesla modules. In order for the preprocessor 340 to function at capacity, it may at least capability presently provided by commercially available models PCI express 4.0 and 5.0. This may approximately be a 133 MHz 64-bit device with a peak single-direction transfer rate of 2000 MB/s.

Further, in order for the node cluster apparatus 220 to function at capacity when integrated as a subsystem into a data management system 200, it is highly desirable to maximize the bandwidth of data transfer within and amongst each subsystem system 220, 140, 206, and 440. The interconnection devices (e.g., interconnect 221, interconnect 309, interconnect 209, interconnect 242, interconnect 9010, interconnect 9020, interconnect 9030, interconnect 492, interconnect 9012, interconnect 9022, interconnect 9032, and interconnect 9040) that have been found to provide sufficient bandwidth typically have a minimum capability approximately equal to 10 gigabytes per second (GB/s). Alternatives to achieve connection and/or interconnection functionality may be done via a direct PCI express connection, Wi-Fi enabled, Bluetooth, network circuits, fiber optics, Ethernet® cat 6A or above, cable, or combinations of the like.

The node cluster 220, preprocessor 340 and the entire DMS system 900 may use an assortment of interconnection cables including commercially available products referred to as NVIDIA LinkX-Optics, LinkX Ethernet DACs and AOCs being 1G-100G's where these cables have been designed for use in high performance computers, supercomputers, and/or hyperscale systems. However, it is understood that these systems are likely to improve and current standards for cables may be an approximate minimum standard. This approximate minimum standard for cables may feature high data transfer rates (e.g., in the range of 10 to 400 GB/s), low transmission losses, low latency, and comply with contemporary IEEE related specifications.

Similarly, a vast assortment of displays having a pixel density of at least 80 pixels per inch and frame refresh rate of at least 60 Hz may be utilized as display units 208, 942 to provide a high-resolution image to the system's user.

The DMS system 900 may have its subsystem modules within a single housing or the subsystems may be distributed and in networked connection with each other. The modules include the DAA subsystem 410, the preprocessor 420, the central processor subsystem 206, and the user interface 940. Accessories 950 and the remote data center 990 are generally external to a single housing and may be networked with the other modules (e.g., the DAA subsystem 410, the preprocessor 420, the central processor subsystem 206, and the interface 940). A sample configuration may have the first module, DAA subsystem 910, remotely locatable and wirelessly connected to a preprocessor subsystem (e.g., preprocessor 340). The preprocessor subsystem may be configured within a single housing having the constituent components: preprocessor (e.g., preprocessor 340) computer program 921, interface 922, and node 925 and in so doing will yield a highly compact unit. The central processor subsystem 206 may be configured as a single housing having the constituent components: processor 932, a central data storage 938, at least one data node 939, and an inter-module interface 934, at least one computer program 936, and at least one central data storage module 938. Thus, the central processing unit 206 can be collocated with the preprocessor subsystem (e.g., preprocessor 340) or remotely located at any suitable cite.

Further, a suitable processor module to serve for the combined processor functions as well as the as a housing unit is the Dell EMC server 7525 manufactured and sold by Dell Technologies or the like. This product has been shown to have the required capabilities for housing all processors, preprocessors, computer programs, storage, nodes, controllers, displays, and sensors, or any combination thereof.

Field Programmable Gate Arrays (FPGAs) may be used instead of ASICs at any location within the data receiving node cluster 220 or in the preprocessor 340. Modern FPGAs are found to have advantages such as: high operational speed, low energy usage, low emitted noise, high package density, low cost, and commercial availability when compared to ASCIs and may be preferred in certain embodiments where these factors are at issue. Combinations of one or more ASIC and one or more FPGA provide solution to the problem of simultaneous optimization of the above cited factors. Currently, the ASIC (e.g., ASIC 326) and the FPGA array provide the highest packing density, smallest package size, low energy losses, and lowest cost for performing the desired function. Mixed signal devices may also be used because the presence of analog, digital and memory circuits can all integrated into a single integrated circuit package which minimizes the number of components required for an application-specific task and the overall package size.

Data processing within the node 320 and preprocessor 340 require the SSI and ML computer programs to provide instructions to efficiently and effectively perform a large number of mathematical operations in real-time. The combination of SSI and ML computer programs provides instructions to the preprocessor to derive and capture knowledge from, and make comparisons amongst, a large number of previously performed computer program operations. From this, the ML may track, calculate, and extract trends and or anomalies and then make periodic updates to the preprogrammed specifications, norms, and protocols and thereby enable the records storage function to become a living-achieve/storage. This combination assures that the preprocessor may self-adjust and self-improve over time thereby minimizing future errors while optimizing operational performance. A portion of the mathematical operations can be performed via one, or more analog devices instead of the above-cited digital processors. At least one analog processor may be deployed within the node 320 or the preprocessor 340 to facilitate management of processing of vast numbers of complex calculations in real time. Suitable analog processors are manufactured and marketed by the Mythic company where integration of the M1076 Analog Matrix Processor within the node 320 or preprocessor 340 and together with one or more ASIC or FPGA may serve in combination to provide complex data processing. The M1076 Analog Matrix Processor is an example of a current analog computing device that provides two important advantages. First, it is highly efficient as it employs novel compute-in-memory operability to eliminate memory movement within neural networks. Second, it is high performance as it enables hundreds of thousands of arithmetic, multiply-accumulate operations to occur in parallel as vector operations.

The data handling, managing, and analyzing needs of the scientific community may range from a solution that provides simultaneous data streaming from several devices to separate imbedded window panes of one or more common display devices such as a personal tablet or high definition, large screen TV. At the other end may be a solution that receives incoming streamed data, then characterizes, assesses, analyzes, and translates some or all of the data into a common format which can be further analyzed and/or achieved by use of custom computer programs to provide instructions to a central processor. Such a solution may consist of a graphic user interface that provides a variety of user-designated data achieving, report compiling, and reporting options. The output may in the form of a written document, an audio and/or a video file, a transmittable file, an encoded file, or combinations thereof.

Complex data is a term that refers to data that presents a challenge in terms of the computational resources needed to process, as well as the difficulty in distinguishing between signal and noise amid the combination of raw information. A laboratory can be viewed as a data factory. For example, data resulting from state-of-art instruments where a steady flow of robotically manipulated samples into a series of chemical analyzers may exist as the norm. In this case, particularly when a large number and variety of samples are automatically fed into analytic instruments which may be in continuous use, huge (i.e., exascale) data collections can be produced over extremely short periods. If any irregularity occurs during the process, large portions of data may come into question as to its validity. Irregularities, such as power outages or “brownouts”, equipment breakdowns, and/or a discontinuity in the rate in which samples are fed into the analyzers, are examples of events that can render the data as “messy”. A difficulty may ensue in distinguishing between the useable data signal portion of the data and any noise data. Consequently, the data will require additional processing resources to separate and recover the useable data. In addition to the volumes of data, other factors, such as type(s), growth rate(s), structure(s), format(s), and availability all contribute to the level of complexity.

A complex data stream refers to a data set composed of data bytes that are arranged and transferred in a dynamic, temporal relationship where the constituent bytes may be in the form of a continuous or discontinuous arrangement. Complexity arises due to the size, structure, constituent types, growth rates, heterogeneity, and degree of dispersion of the data. An example may be data comprised of massive volumes and multi-modality that follow a different internal logic or structure from other data being processed.

Artificial Intelligence (AI) is a technology field generally referred to as the ability of a computer to perform tasks commonly associated with intelligent beings. AI is often associated with machine learning (ML), deep learning (DL), and natural language processing (NLP) which are complementary technologies that are all part of the AI landscape. However, each is considered separate and individually different in functionality within the context used herein. For the purposes used herein, an arithmetic computer program is used to provide instructions for searching for an optimum solution to a complex numerical problem, based on the principles of natural selection.

The path to a solution may, for example, create several solutions (a population) by setting selected parameters randomly throughout a search space. From this population of solutions, the worst are discarded by comparison with a pre-established standard and the best solutions are then intermixed with the remaining other parameters from the most successful set of originals, thus creating a new data-derived population. The process continues through many iterations with the best outcomes representing a final solution set.

Specialized Synthetic Intelligence (SSI) is employed herein as a specific subset of AI to refer to a capacity of computer software when deployed in combination with supporting hardware to receive and process data, employ computer programs to impart reason (i.e., to provide instruction to conduct reasoned thinking), draw conclusions and act upon the conclusions that are drawn. As used herein, SSI is provided in a form considered to be an independent form of intelligence and not just a surrogate for AI.

Thus, SSI is considered herein to be an evolutionary advancement over AI as SSI software goes beyond simulation, taking advantage of the ways that machines acquire and apply knowledge and abilities at both the digital and mechanistic levels.

Machine Learning (ML) is defined as the area of Artificial Intelligence that focuses on developing principles and techniques for automating the acquisition of knowledge. Some machine learning methods, such as supervised learning and/or unsupervised learning, can extract knowledge directly from existing databases and in so doing self-learn methods that are enabled by selected software systems that mimic human learning.

Data translation is meant to describe the process of converting data from the form used by one system into the form required by another.

Smart data converter-refers to the integration of hardware, firmware, and computer software into an apparatus that is between an incoming complex data stream and a subsequent computer-based function. The converter provides digital data streams to undergo translation or transformation from an initial state into a form and format that suitable for communication to and subsequent computer program processing by a suitably programmed processor.

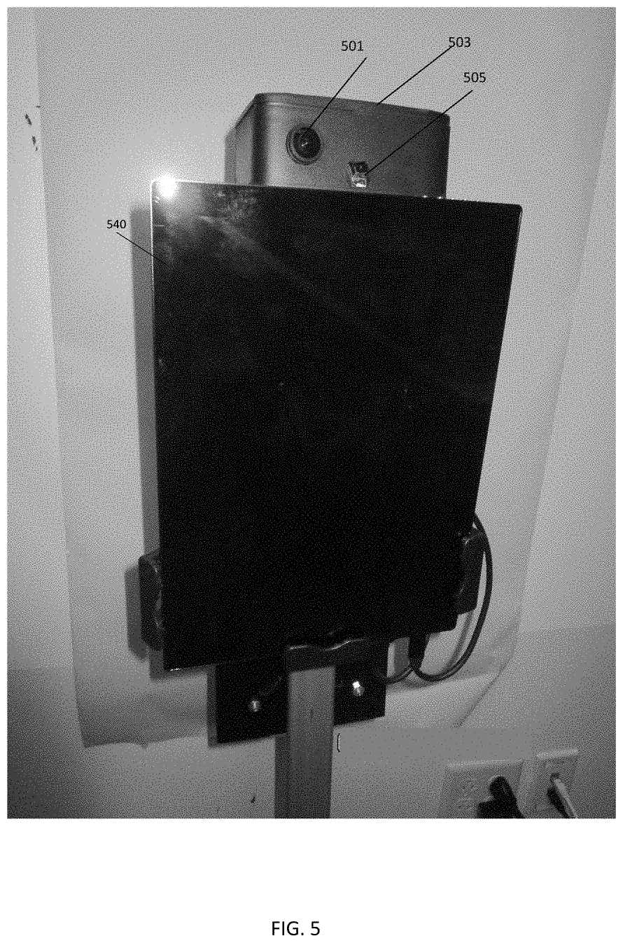

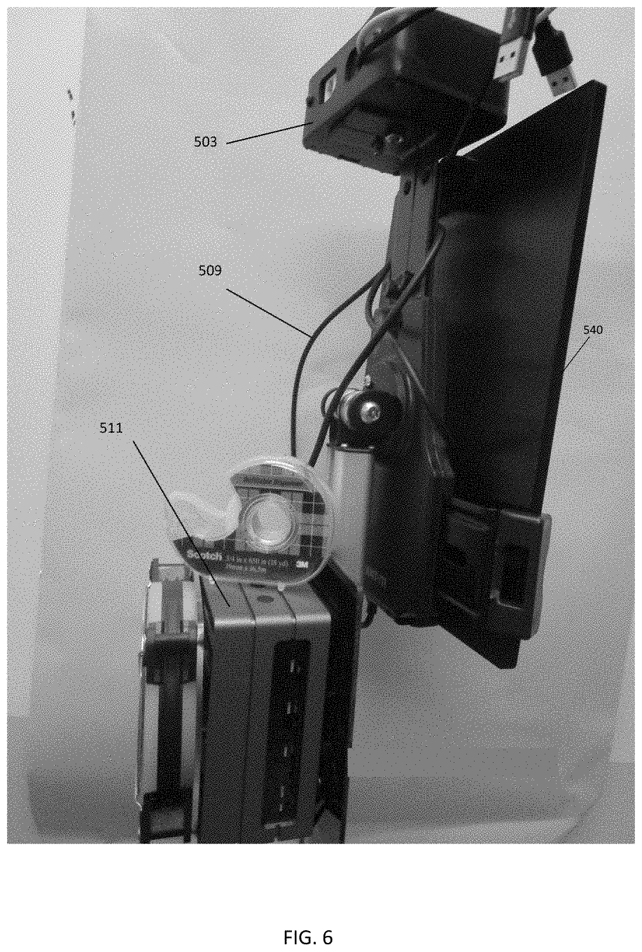

With reference to FIGS. 5 and 6, a data acquisition apparatus (DAA) 503 is shown. The DAA 503 has a camera 501, a temperature sensor in the form of a thermistor (not shown) measuring internal and external temperature of an experiment, a display 540, and a thermal camera 505. The data acquisition module depicted has within a processor, memory (random access memory (RAM)), and a frequency modulator. The DAA 503 communicates with a node cluster 511 by connection 509. Connection 509 is a connection which may, for example, be a cable or similar device through which data and/or power are transmitted. While connection 509 is depicted as cable, communication between the DAA 503 and the node cluster 511 may be by radio frequencies, such as, for example, Bluetooth or Wi-Fi. In an alternate embodiment, the node cluster 511 may, for example, have internal programing providing instructions to each sensor.

With reference to FIG. 9, the system shown in FIGS. 5 and 6 will be described in greater detail. FIG. 9 provides a block diagram showing a data acquisition apparatus (DAA) 910 corresponding to DAA 503. The DAA 910 has a camera 911 (e.g., corresponding to camera 501), a temperature sensor in the form of a thermistor 915 measuring internal and external temperatures, and a thermal camera 912 (e.g., corresponding to thermal camera 505). The data acquisition apparatus produces a continuous stream 9010 (e.g., corresponding to connection 509) of raw data that may be characterized as high volume, multimodal, and complex.

Raw data arrives at the node cluster apparatus 220 (e.g., corresponding to node cluster 511). The node cluster 220 has a preprocessor (e.g., preprocessor 340), with the preprocessor, SSI/ML computer program instructions, and a random access memory (RAM) storage element, forming what may be referred to as a pre-processor subsystem 220. The DAA 910 communicates with a node cluster via a one-way connection 9010 which may, for example, be a cable or similar device through which data and/or power are transmitted. While connection 9010 is depicted as cable, communication between the DAA 910 and the node cluster 220 may be by radio frequencies, such as, for example, Bluetooth or Wi-Fi. In an alternate embodiment, node cluster 220 may, for example, have internal programing providing instructions to each sensor via a return path connection 9012.

Node cluster 220 may have internal components similar to those described in the block diagrams of FIGS. 3A-3C and FIG. 4, with both the node cluster 320 and the preprocessor 340 housed within a housing (e.g., node cluster 220). With continued reference to FIGS. 9, DAA 910 may have, for example, internal programming receiving data collection instructions via connection 9012 from the node cluster 220 that is configured to coordinate the output from the camera 911, thermal camera 912, and the thermistor 915. The node cluster 220 may include a plurality of master nodes or arrays 324 with each master node connected to a plurality of nodes which are in communication with the connected master node. Each of the plurality of nodes may be, for example, an ASIC as depicted in FIGS. 3A-3C, with each ASIC providing instructions and processing capacity to collect data from at least one sensor housed within a DAA 910. The number of nodes associated with each master node may vary with the operations being performed and the data being collected. In one embodiment, there may be, for example, one to three nodes per master node.

With continued reference to FIG. 9, the camera 911 output may be in a digital image or digital video output that conforms to any of the standard file types. For this example, the digital image file created by the camera 911 may be in a .jpg format. This format may be a standard for the camera 911 or it may be a storage format selected by the node from the node cluster 220. Continuing with this example, the thermal camera 912 may create a digital file in a .fpf format. This format may be a standard for the thermal camera 912 or it may be the storage format selected by the node from the node cluster 220. The thermistor may create a digital file in a .ino format (i.e., a file in the C or C++ programming language).

Within the node cluster 220, the information regarding the digital files and their associations may be stored, for example, within a log file, while the digital files themselves may be stored in another storage system (e.g., central data storage 938 or the remote data center 990).

Each node from the plurality of nodes and each master node from the plurality of master nodes generates a log file. The log files from the plurality of nodes that belong to an individual master node are categorized by the master node and the content of those log files is organized by the master node.

The node cluster 220, particularly the plurality of master nodes, may determine what data is relevant or irrelevant before passing the information to the central processor. Determining relevant or irrelevant information may be based on initial parameters that are adjusted through initial master node training and eventually adjusted by the processor of the master node as the master node continues to process data.

Each of the master nodes may also, for example, perform diagnostic monitoring of each of its associated nodes. The diagnostic monitoring may include checks for programming and operational corruption, and may also include commands to reset or repair a node's programming.

The preprocessor may, for example, receive information from the log file or may be sent the digital files themselves. If the log files are sent, then the preprocessor may pull the data files based on information from the log files. If the files themselves are sent to the preprocessor, the preprocessor may perform an assessment on the file details received and adjust its operation based on the file types received.

The preprocessor performs file translation. By file translation, it is understood that this entails file diminution, augmentation, or some other form of file format change and/or file compression. The purpose for translation is to create compatible file types, so that such file types may be combined or combinable for further data processing. The preprocessor may perform its file type compatibility based on, for example, least resource usage to make a particular compatible file type. Other parameters for preprocessor translation may include, for example, converting to a particular file type or converting to compatible file types based on resource boundary settings, or even based on maximum resource usage and least time to complete. Another example of a data type criterion may be the operating system of computers used by the users at an endpoint. If the computer has a Linux operating system, then the output file types may be different from those of a Windows system.

The preprocessor may, for example, monitor the volume of data and the data rate from the node cluster 503. The preprocessor determines what actions need to be performed first and then the preprocessor determines the order of steps. This priority determination and operational plan may be, for example, determined by a system that is given an initial set of parameters. The parameters may be adjusted as the system is self-trained, and then the parameters are adjusted by a processor as the preprocessor system continues operation. A portion of the mathematical operations and parameter adjustments may be performed by traditional digital means and devices (ASICs and FPGAs) while another portion may be performed by analog methods and devices. In the case where raw data is provided by the DAA 201 or DAA 910 solely in digital form, an ASIC can be designed and deployed to accommodate its processing without a lot of overhead that may be associated with extensive data reformatting operations. Thus, a compact, highly efficient, and low-cost device can be selected to meet the requirements of this scenario. At the other end of the spectrum where multimodal raw data include combinations of digital and analog formats originating from a multiplicity of DAAs, data may be streamed to the node cluster 220, and an FPGA that configured to accommodate this blend of data formats may represent a better (i.e., a faster, more operationally efficient and cost effective) option.

Once an output format is determined by the preprocessor, data is translated into machine augmented data MAD and may be sent to a central processing system (e.g., central processor 206 FIG. 2 or central processor node 932 of FIG. 9). Data received is then processed by the central processor 206 which may be co-located or remote. End users may provide filters and parameters to assist the data management system in providing output data desired by the user. This may provide the user with, for example, options to group data, combine data, highlight data, or eliminate data from view. This is not a complete listing of data manipulation options, and one skilled in the art would understand that other options for data organization exit.

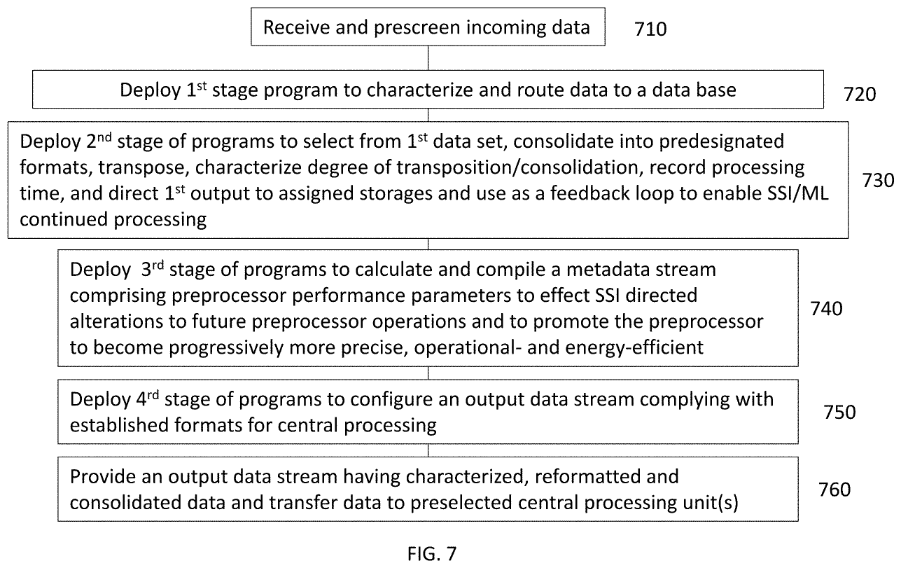

The flowchart FIG. 7 and block diagrams in the related Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The data receiving node cluster 320 is configured with at least one of an application specific integrated circuit (ASIC), a field programmable gate array (FPGA), a data storage member, and a specialized synthetic intelligence (SSI) computer program to translate/convert data files and provide instructions to create an intelligent node cluster. The preprocessor 340 may be configured with at least one of an application specific integrated circuit (ASIC), a field programmable gate array (FPGA), a data storage member, and a specialized synthetic intelligence (SSI) computer program wherein the SSI computer program is configured to enable screening, selection, validation, re-configuration, and transfer of incoming multi-modal data streams that can convert the data streams into a common stream of machine augmented data (MAD) suitable for subsequent processing, such as: central processing, remote processing, achieve storage, or selected other downstream operations. At least one of the ASICs or at least one of the FPGAs may be shared for used by the data receiver 320 and the preprocessor 340 functions.

In one embodiment, the data receiver/preprocessor system 220 is composed of an array of ASICs (referred to as a “data receiving node cluster” 326) configured within a container where a primary ASIC is provided as the main recipient of the incoming data and serves to prescreen and direct secondary operations performed by secondary ASICs (which can be referred to as “worker ASICs”) having computer programs to provide instructions to handle large, complex data volumes and to enable SSI and participate in self-learning. So configured, the array of ASIC can be referred to as a layered array.

In one embodiment, data translation of some or all of the data may occur solely within the preprocessor system 340.

The functioning, capabilities, and methods of the invention herein will be better understood by reference to FIG. 2, FIG. 4, and FIG. 7 and to an example referencing a chemical processing plant. The present invention is intended to provide an apparatus and method that elevates data management to a level that provides autonomous operations of the plant.

The plant manufactures and supplies custom fruit-based beverages that meet specifications and comply with purchase orders provided by the firm's clients. It processes a vast number of pre-liquified fruit nectars in order to produce hundreds of different beverage-compositions that are bulk shipped to and repackaged by clients for regional retail sales. The plant can process any nectar type, for example: apple, pineapple, grape, cranberry, cherry, mango, citrus, etc. that has been extracted in liquid form from the corresponding fruit. The liquified fruit nectars represent the majority of incoming raw materials which are transported and arrive at the plant by a system of dozens of pipes feed by fleets of tanker trucks that deposit their payloads to a central receiving and distribution depot located close to the plant. A large conglomerate owns and operates the plant and has several similar ones throughout North America.

Source-provided, raw data pertaining to time-of-receipt factors such as lot number, product code, fruit type, fruit variety, environmental history, net amount delivered, source of origin, date of origin, date and time of delivery, name of transporter, and various accounting data is taken from the delivery manifests FIG. 7, 710 and directed electronically to an incoming materials' data base FIG. 7, 720. Within the data receiving-preprocessing operations, an SSI/ML program 720 is used to organize, record, and prepare for later processing a set of related factors which define the spectrum of incoming raw materials data. As daily materials' deliveries occur throughout the year, parametric values for each factor are added continuously to the incoming materials data base. In addition to the factors and parametric values that are recorded, the number of characters for each parametric value may be considered by the data management system. Thus, the data base and computer programs providing instructions are designed to manage a large and ever-growing volume of complex, multiparametric data.

The pace of data input and processing by the various computer programs interacting with the data storage devices must occur at a very rapid pace so as to not impact upon material flow throughout the plant's physical processes, thus the data processing rate as well as its security become critically important performance metrics.

For example, there are more than 350 worldwide time-date formats in general use. Some are alphanumeric, some are numeric, some use separating slashes or dashes, some use separating dots. While many employ the Roman numerals and the English language, this is not the universal practice globally. Clearly, without knowing the source origin and other contextual details, a data entry such as simple as a date and time of a delivery can be misinterpreted and lead to errors and/or data processing delays. The systems described herein may use the ISO 8601 format YYYY-MM-DD (2022-08-30) in order to harmonize the formats into a single format and to provide accuracy. Thus, in one of its operations, the preprocessor may characterize all date and format constructs provided with incoming raw materials and transpose each into the ISO format (see 730 of FIG. 7). This transposed data is then employed to facilitate downstream computer program processing and data storage.

The preprocessor serves to reformat certain data sets. Should an anomaly or defect in the re-formatting processes be determined during early data processing, its discovery is recorded as part of an SSI/ML protocol 730 and a rectifying command set is compiled and fed as part of a feedback loop to alter the affected data cell(s), to revise the record, and to finalize the rectification process. If rectifying attempt fails, a predetermined default value is deployed, the event is noted in the record, and a later stage computer program is used for further analysis and to continue the self-learning process 730. This may be a form of machine self-learning and/or computer program correlation processing. At an early stage of learning the computer programs are designed to provide instructions to detect and correct anomalies. Over time, a record is kept, and the computer programs are designed with instructions to identify patterns that occur and by trial and error (i.e., self-learning) methodologies, attempt remedial trials, assess success, and self-select and carry forward with the best performing option.

Other source data formatting used by the various delivery services can be widely variable and may depend on the country of origin. For example, the amount of product contained in a delivery may be stated in volumetric quantities (barrels, gallons, liters, etc.) or in gravimetric quantities (tons, kilograms, etc.). The inventive preprocessor functions to characterize time-of-receipt data and employs at least one data base 720 and at least one computer program to provide instructions to convert such data into pre-established formats 730 and permit the start of compilation an output data stream suitable for central processing 750.

Source-supplied data, which typically is unstructured and multi-factor, may be provided to the system via manual or barcode or QR code entry upon delivery arrival, via telecommunicated link at any time prior to delivery arrival via script-recognizing scans of the manifest, via RFID tags, or any similar means employed by the transporter.

The amount and types of incoming data entering the system 220 via data connections 205 and data ports 322 are found to be highly variable amongst the various delivery sources and even the means of communication of said data to the system may be highly variable.

Upon initial transfer of incoming materials to the plant, a system of data acquiring sensors (e.g., temperature sensors 915, contacting or non-contacting sensors 916, and/or sensors configured to gather desired details from the raw materials being sensed) are connected by data ports and interconnects to transfer raw data to the preprocessor (e.g., preprocessor 340) which serves to receive, communicate, characterize, and continuously monitor the incoming raw materials' streams and local environments. Due to the need for controlled environments for all transport and storage operations in order to assure product freshness and to prevent spoilage, data relating to environmental exposures (e.g., temperature sensors 915) during and prior to in-plant processing are relevant data elements. Other sensors may be configured to measure key factors such as viscosity, density, sugar concentration, mass of suspended solids, Ph level, concentration and types of dissolved gases and solids (such as sodium and potassium), caloric content, and the like.

Each of these factors may vary greatly from one lot of incoming nectar to another. Consequently, no common production formulation nor standardized process for the entire span of in-coming and out-going products exists.

Client provided purchase orders may contain accounting data, such as pricing, delivery dates, billing, labelling, and shipping requirements along with any special instructions also become critical elements correlating to each incoming material that are received and managed within the system.

Referring to FIGS. 2, 4 and 7, portions of the incoming 710 and stored data may be selected and designated for temporary storage via an internal operation designated as buffer storage, or, for long-term storage (also referred to as a library) by the processing unit 140. A layered series of computer programs (e.g., first stage computer program 720, second stage computer program 730, third stage computer program 740, and output stage computer program 750) employing at least one SSI program, may be incorporated within the preprocessing assembly (e.g., data receiving node cluster 220 and preprocessor 340). One of the functions of the SSI enhancing computer programs within the processing unit 140 is to oversee the data base of real-time operations, compare most recent data processing operations to those earlier established relating to similar operations, and dynamically update entries to the data base(s). Using the new data, an SSI function is to compile new data-processing options, screen and select promising data processing options, and direct alterations through a continuous exchange between the node cluster 220 and preprocessor 340 of updated instructions to improve the flow and process efficiency of future operations.

The array 324 (e.g., an array of ASIC and/or an array of FPGA) has of at least one of a field-programmable gate array FPGA and at least one of an application specific integrated circuit ASIC with the types and number of each providing data throughputs and computational loads that operate at a capacity of about 25% to 50% of the theoretical maximum required for management of the critical requirements. The notion of initially configuring the preprocessor at a reduced capacity is intended to enable future growth and logistical flexibility without the need for hardware updates and to provide bandwidth for a continuous flow of SSI (i.e., internally created) processing updates. The devices within the array 324 may be configured into groupings that are layered into arrays of arrays and interconnected by direct connection or by high-speed interconnects. A role of at least one SSI computer program 730 is to monitor present-time efficiency given the present-time incoming data volume and the time spent on processing the present data load and reallocate select data sets and configuring operations 740 to provide for alternative arrangements of FPGA and ASICS in order to better utilize capacity, to self-establish the most efficient alternative grouping of constituent elements, and to employ adjustments to data flow through the array during subsequent processing operations.

The range of data types involved in front-end operations of this plant range from; a) incoming materials data 710 that is unstructured multifactorial representing variables that may be expressed in alpha, alphanumeric, and/or numeric formats having continuous or discrete values, to b) in-process generated and control data that is digitally structured having continuous and/or discrete values 730, to c) machine augmented data MAD generated by SSI computation 740 that has been optimized for communication to selected central processors and efficiently used to alter future actions by the preprocessor 140, 730, 740 as well as by a suitable central processor 206. At various stages of preprocessor operations, data may take on any form including alpha characters, integer numbers, floating-point numbers, exponential numbers, Boolean numbers, and expressions as well as complex numbers.

In one embodiment, the preprocessor is configured with at least one computer program that provides for a specialized synthetic intelligence SSI functionality. For example, an SSI computer program is constructed to characterize the initial format employed for receiving and recording numeric data within associated number-fields within a particular storage location. Since there are vast number of such fields, the initially designated data storage volume may be overstated and unnecessarily large. By monitoring and characterizing the actual incoming data over a period of time, such as for example one month, the computer program may recognize that the initially formatted size of these fields exceeds that actually required and will operate to compile and to initiate directives that result in reformatting of some, or all, of the data storage fields used for numeric data storage. Thus, the immediate need for large storage volumes is reduced and future storage flexibility is created. Similarly, using an SSI-enabled operation, the preprocessor may employ achieved data and prior learning experience to determine the minimum number of significant figures required for all subsequent mathematical operations and to employ this determination to direct the preprocessor to truncate all unnecessary characters during its future internal data generating operations. The benefits here are that; 1) only the minimum dynamic storage is required at any point in time, 2) time and energy consumed by storage operations is reduced, and 3) complexity and volume of the MAD stream is optimized thusly increasing overall system efficiency.

In another embodiment, the preprocessor is configured with at least one SSI operation where at least one computer program constructed to characterize incoming data and seek out correlations amongst various data. By having a data link to outcomes of downstream physical processing in the plant, the SSI computer program can calculate correlating factors amongst all in coming and in-process data. The computer program is then used to select and construct a subset of data that may have high confidence correlating factors and then functions to reconfigure the content of the MAD stream to utilize the subset, or alternately a derived synthesized data set, as a surrogate for the otherwise larger, more complex data set. By distributing in the initial stages of data processing to a highly productive, low cost, and energy efficient preprocessor 340, the later stages of data and its downstream processing can continue on a pathway 242 to the central processor 206 where the effectiveness and efficiency of the central process may be optimized.

An example of the synergistic use of complex data coupled with SSI compiled and directed commands during an early stage of incoming materials processing is used to further describe the operability of the inventive system providing for one aspect of autonomous operation of the plant. The node cluster 220 receives source-supplied and incoming-receiving data 710 which is routed to and stored within a data base 720. Newly generated data that is obtained from custom in-process sensors is continuously added to the data base thusly creating an ever-expanding, integrated data set that resides within the preprocessor 340 or alternately within a remote achieve designed as a shareable mass storage 440. The plant uses thermal pasteurization during the early stage of materials' processing in order to destroy any microorganisms and enzymes (i.e., pathogens such as escherichia coli, salmonella typhimurium, and listeria monocytogenes along with various other spoilage organisms) that may reside within the nectars and thusly assure that the final products are safe and free of pathogens, are of high-quality meeting consumer specifications, and minimizes commercial losses. To achieve this, a number of physicochemical properties must be monitored at various stages of processing. The earlier mentioned factors: viscosity, density, sugar concentration, suspended solids, Ph level, concentration and types of dissolved gases and solids (such as sodium and potassium), contaminant types (particularly organophosphorus pesticides) and their levels, and caloric content may be monitored at any point during the production process.

Thermal pasteurization is performed by subjecting the nectar stream to heat treatments that range from 60° C. to 100° C. for periods of exposure that range from a few seconds to several minutes. Since heat exposure can cause deleterious effects (such as color changes, deterioration in nutritive values and sensory characteristics and accelerate spoilage), the temperature—time exposure must be kept to the lowest possible level. Further, since some contaminants are thermally tolerant, a combination of thermal pasteurization coupled with a complimenting process, such as gamma irradiation, may be prescriptively used within modern plants. The challenge is to identify and match the combination of thermal treatment with gamma irradiation thereby creating a 2-step integrated process which is used to destroy targeted pathogens while retaining the desirable and nutritional value (i.e., flavonoids, antioxidants, and various organoleptic) properties of the end products.

As example, resulting from earlier data preprocessing operations, the level of pathogens has been (hypothetically) correlated with high confidence to an SSI calculated factor representing a convolution factor, such as, for example, a factor designated as F(con) to represent the cross product of computer program instruction to calculate using several subfactors; specific density, Ph, and dissolved oxygen and nitrogen where F(con) has been created by synthetic derivation. While the F(con) factor can be viewed as abstract in that it has no direct physical counterpart, it has been deemed to be quite useful in this particular setting. Numerous SSI conducted determinations have established that the value of F(con)moves in sync with the values of the subfactors. That is, as the values of each subfactor move directionally upwards or downwards, the factor moves accordingly. Thus, the convoluted factor F(con) is useful not only as a real-time monitor of the integrated process, but also as a process control factor that is used to learn, compile, and direct alterations of running conditions of the integrated process.

Custom sensors 919 are used to generate a data stream, including parametric values that represent dynamic changes in the levels of the subfactors. Data is communicated to 9010 and received by the node cluster 220 where the AI/ML/SSI computer program embedded within the preprocessor subsystem 921 provides instructions to recognize and analyzes the data stream and calculates an instantaneous value of F(con). A comparison of the instantaneous value of F(con) to a pre-established range representing acceptable and low levels of pathogens and to the present state (i.e., time-temp and gamma level) of the integrated process is used to determine if the present state is adequately yielding the intended result (viz., destruction of any pathogens). If the comparison fails the acceptability test, the SSI functions to compile a command and communicate the command to each of the sub-processors (viz., to the heat treatment subprocess and to the gamma irradiation subprocess). In the event of a comparison failure, the SSI activates a machine learning, test-and-learn mode enabled by a programmed SW routine where it compiles and sends a set of new operating set points 730, 740 having incrementally altered values that are received by and executed within the subprocesses set. The subprocesses adjust to the new set points and initiate actions to act upon an interim quantity of material, gather new data which is fed back 9022 to the preprocessor (e.g., preprocessor 340), which continues in the procedure of comparing, compiling, and issuing new set point instructions to the subprocesses until such point as the F(con) value converges to an acceptable level. The preprocessor then serves to create a data set that serves to archive details of the event that is transmittal to and stored within a designated data base. The preprocessor also serves to direct any discrepant material that has been created during this remediation process to a suitable repository for remedial processing or for disposal.

Over a period of time where several or more acceptability tests fail, the number of individual records may grow to the point that an appropriately designated event library may be constructed, where a specific data base may have the format of a look-up table for future use by the preprocessor. Data, such as time and date of occurrence, data anomalies that triggered SSI actions, actions taken by the preprocessor when similar events have occurred where the preprocessor has recognized the event, compared it to prior experiences recorded in at least one data file 4938 in an accessible archive, determined similarities to prior events, extracted the record of alterations used in similar prior events to remedy the earlier issue(s), the SSI computer programs are then employed to compose and transmit a new set of set points to the subprocesses where the new set points are the product of previously experienced learning.

In the event of ongoing acceptability pass results indicating no significant to factor F(con), the preprocessor continues in its routine operations as there may be no trigger for entry into a fault rectifying mode.

Another important operation enabled by the preprocessor working in concert with a central processer includes a specific aspect of data processing that relates to financial transactions corresponding with every incoming and outgoing materials' shipment. Upon receiving and characterizing data from a particular lot of material delivered and tracking it through processing within the plant, the processors work synergistically to calculate and issue payment(s) which may transfer directly to the materials' source automatically, electronically to the client's account in real time. Likewise, an invoice for payment due may be issued to the recipient which may include specific details of shipping logistics and tracking of the final product(s).

In another embodiment, the preprocessor serves to manage a predefined data set relating to maintaining critical records and auto-issuing periodic reports. In this role, the preprocessor selects and designates portions of the data for long term storage, compiles (by calculation) and configures data into configurations suitable for external transmission such as those that may be required by governmental agencies such as the FDA.

The above-described amounts and types of data require a vast computational and data management capability that must be closely synchronized with material flows and with real-time physical operations within the plant. Unfortunately, such a capability does not exist with contemporary data management systems and thusly creates barriers for those seeking to operate fully autonomous factories.

The configuration, functionality, and methods of use are described herein with reference to certain examples. Importantly, the examples selected for description represent only a portion of the configuration and usage options. One skilled in the art would understand that there may be other configurations, functionalities, applications, and methods of use.

Combinations of commercially available, open-source programming and custom code may be used to create the various computer programs providing instructions executed via the preprocessing elements, ASICs, and FPGAs. Examples of such open-source languages are Py Tourch, TensorFlow, CUDA, Anaconda, AMD ROCm, etc. FPGAs are commercially available from large manufactures such as AMD (Xilinx) and Intel (Altera) as well as from various smaller custom suppliers such as Efinix, Acronix, and Mythic. A wide variety of ASICs are available from firms such as Intel and ALD.

The efficiency of the preprocessor may be heavily dependent upon interactions between memory and computer program instructed computations, one embodiment of the inventive system may be configured to provide full-load operations at the fastest operational process and with lowest power levels possible. This may be accomplished by using at least one custom SSI computer program that serve to balance and optimize the use of at least one of a conventional calculate-with-memory CWM protocol with at least one of a complementing compute-in-memory CIM operation. The hardware used in the system has at least one of a dynamic, high-speed random-access memory such as the SDRAM-DDR4 Memory IC 4 Gb manufactured by Integrated Silicon Solutions or similar manufactured by Micron Technology and marketed by Dig-Key Electronics, Thief River Falls, Minn. The system further has at least one compute-in-memory processing device such as the MP10304 Quad-AMP PCIe card and the M1076 that integrates 76 AMP tiles to store up to 80M weight parameters and execute matrix multiplication operations without any external memory. These are manufactured and marketed by Mythic, Austin Tex.

With reference to FIG. 2, FIG. 3, FIG. 4, and Fig, the data management preprocessor system has the data receiving node cluster 320 and preprocessor element 340 configured to receive and manage vast amounts of complex data from a wide variety of sources (e.g., 201, 410, and 910) and data storage (e.g., 440 and 921). The data receiving node cluster 320 and the preprocessor 340 can be integrated and housed within a single device package having a compact size of about 50 to 500 cubic inches. The device may include at least one of; a data input port, a data output port, a power connection, an ASIC, a FPGA, and embedded AI/ML/SSI software. The device 511 shown in FIG. 6 represents a working embodiment of such an integration including a preliminary (1^{st} stage) computer program 720, an ASIC array 324, a preprocessing unit 420 having a FPGA (not shown), a grouping of computer programs 921, 730, 740, 750 and two interfaces 922 that work synergistically to create, manage, and provide interconnecting data streams 9010, 9012, 9020, and 9022. Data having any initial format (e.g., .jpg, .fpf, .ino, etc.) as supplied by one or more DAA 201 may be streamed to the input port of the device 511. The incoming data may be screened, characterized, segregated, and compared with archived data, whereafter data portions are stored, reformatted, and configured into an output stream 9020 serving as the input to a central processing unit 206. Displayable outputs from preprocessing (e.g., from preprocessor 340) or central processing 206 of incoming or in process data, or any processing operation or in consolidated or summary form can be delivered to a user via a user interface 922 (e.g., a graphical user interface (GUI)) or in an alternate embodiment, by bypassing the central processor may be transmitted directly to a suitable display device 540. Data or computer program derived results may be displayed in a range of user selectable forms, such as view graphs, data tables, video and the like.

FIG. 8 is an example of an integrated graphic display of dynamically captured data from a single, multifunctional DAA 503 represented in the format of three time-based plots 801, 802, 803 of data captured during an experiment. Experimental parameters include a DAA 811 (described as sensor 911 which is a high resolution, color digital camera); using soft/firmware 812; the input port used for this incoming data 813; and the data rate 814. From FIG. 8, a vast amount of incoming data (for example in the range of less than 10 Terabytes to more than 1000 Terabytes) may be processed at data rates (for example in the range of approximately 10 Gb/s to greater than 1 Tb/s) in real time where selected data may be presented to an end-user in a useful format.

The earlier described system 200 and particularly the node cluster 220 having various data acquisition, preprocessing, SSI and/or ML computer programs and interfacing devices can be adapted to meet a wide range of unfulfilled needs of the medical, medical research, biological, and energy research fields. The inventive device in the form of a compact package having the above-described elements (320, 340) may be used in any data-intensive environment.

In another embodiment, the inventive data management system may have at least one data preprocessing system configured for receiving, monitoring, analyzing, configuring, and directing data using real-time, in-situ, specialized synthetic intelligence SSI/ML programs and directing actions based on the outcome of SSI enabled processing.

The inventive preprocessing system employing SSI may serve to determine and direct actions executed to improve the flow of data through the system. By comparing the types and volumes of raw incoming data to norms stored in at least one memory and accessible to the SSI computer programs, specific data management instructions are derived and communicated to at least one of the nodes that act upon the directives provided by outputs from the SSI computer programs. At least one action enabled by directives from the SSI operating within at least one of the nodes to provide at least one of; analysis, segregation, partitioning, rearranging, staging of raw incoming data into constituent elements, generating executable instructions, and altering at least one set of operating conditions of at least one system accessory. The constituent data elements may then be reconfigured into data streams having commonality of format and structure that provide for more efficient transmission to and receipt by subsequent process computers and/or user displays.

The inventive system employing SSI and serving to reconfigure the raw incoming data into an output data stream to facilitate transmission to and processing by subsequent processors thereby improving the efficiency of data transfer.

The inventive system employing SSI to derive and direct actions that improve the flow of data through the system employs at least one machine learning (ML) program that serves to capture, analyze, and record the real-time SSI issued directives and content. The ML program is central to a method that compares the directives and content to emerging norms having performance parameters such as, for example, the number and time required for data management operations, (i.e., reconfiguration and transfer), operations per second (OPS), operation types, and energy utilized. The ML enabled methodology provides real-time identification, selection, and adaptation of those actions that produced the best relative performance.

The inventive preprocessing system employing at least one of an ASIC, a FPGA, a temporary storage device, a permanent data storage device, and a computer program providing computational instructions to the at least one ASIC and/or the at least one FPGA, the at least one temporary storage device, and the at least one permanent storage device. The system constituents are selected, integrated, and interact cooperatively to manage vast amounts of complex data.

Although various embodiments are described above, these are only examples. For example, computing environments of other architectures can be used to incorporate and use one or more embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

In some embodiments, aspects of the present invention may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, an optical storage device, a magnetic storage device, or any combination of the foregoing. The computer readable medium may be readable by a processor, preprocessor, processing unit, or the like, to obtain data (e.g., instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C #, Java, Python, etc.

Program code can include one or more program instructions obtained for execution by one or more processors. Computer program instructions may be provided to one or more processors of, one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although various embodiments are described above, these are only examples. For example, computing environments of other architectures can be used to incorporate and use one or more embodiments.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment(s) chosen and described are to best explain various aspects and the practical application, and to enable others of ordinary skill in the art to understand various embodiments with various modifications as are suited to the particular use contemplated.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

What is claimed is:

1. A system for managing large volumes of complex data, comprising:
a node cluster comprising:
a data receiving node cluster comprising:
a plurality of integrated circuits;
a computer readable storage medium having a computer program providing instructions to the plurality of integrated circuits;
a plurality of data acquisition ports, at least one connected to a data acquisition device transmitting data to the plurality of integrated circuits;
a plurality of data receiving ports; and
a plurality of data transmitting ports;
and
a preprocessor comprising:
a processor;
a computer readable storage medium having a computer program providing instructions to the processor;
a plurality of data receiving ports, at least one of the plurality of data receiving ports connected to at least one of the plurality of data transmitting ports of the data receiving node;
a plurality of data transmitting ports, at least one of the plurality of data transmitting ports connected to at least one of the plurality of data receiving port of the data receiving node, and at least one of the plurality of data transmitting ports connected to a central processor;
wherein data acquired by the data acquisition devices is received by the plurality of integrated circuits, categorized, logged in a log file, and the log file transmitted to the preprocessor;
wherein the preprocessor receives the log file and transmits a request for data, based on the log file, to the plurality of integrated circuits, and categorized data is received by the preprocessors;
wherein data is translated by the preprocessor and the translated data is transmitted to the central processor.

2. The system of claim 1, wherein the plurality of integrated circuits comprises application specific integrated circuits.

3. The system of claim 1, wherein the plurality of integrated circuits comprises field programmable gate arrays.

4. The system of claim 1, wherein the plurality of integrated circuits comprises a layered array.

5. The system of claim 4, wherein each of the plurality of node clusters comprises:
a master node having at least one processor having at least one integrated circuit; and
a plurality of subordinate nodes each having at least one processor having at least one integrated circuit.

6. A computer implemented method comprising:
acquiring, by a data acquisition apparatus having at least one processor, data from at least one data source;
transmitting data to at least one node cluster having a master node connected to a plurality of nodes, the master node having at least one processor and the plurality of nodes each having at least one processor;
receiving, by at least one processor, data in one of the plurality of nodes;
storing data in a file type based on preset parameters and correlated with the data received;
logging data information in a log file, the data information comprising:
data storage information;
the data file type; and
data file information association;
organizing, by the processor of the master node, contents of the log file;
determining, by the processor of the master node, relevance of the log file contents and the stored data, the relevance based on parameters;
adjusting, by the processors of the master node, the parameters;
sending, by the processors of the master node, the log file information and the data storage information to a preprocessor comprising at least one processor;
translating, by the at least one processor of the preprocessor, received data;
matching, by the at least one processor of the preprocessor, file types to the data file information association;
organizing, by the at least one processor of the preprocessor, translated data;
transmitting, by the at least one processor of the preprocessor, translated data;
receiving translated data, by at least one processor of a central processing node, the central processing node further comprising a memory, and data storage;
converting, by the at least one processor or the central processing node, translated data into a final output data.

7. The computer implemented method of claim 6 wherein translating received data further includes:
identifying file types; and
converting each file type to a file format based on preprogrammed parameters.

8. The computer implemented method of claim 6 further comprises storing final output data.

9. The computer implemented method of claim 7 further comprises:
receiving incorrectly processed files;
processing the files to correct the format; and
transmitting the corrected files.

10. A system comprising:
a plurality of computers each having
a memory; and
one or more processor in communications with the memory;
program instructions executable by the one or more processors via the memory to perform a method, the method comprising: wherein the system is configured to perform a method, the method comprising:
a computer-implemented method comprising:
a data organization method comprising:
acquiring, by a data acquisition apparatus, data from at least one data source;
transmitting data to at least one node cluster having a master node connected to a plurality of nodes;
receiving data in one of the plurality of nodes;
storing data in a file type based on preset parameters and correlated with the data received;
logging data information, data storage information, the data file type, and data file information association in a log file;
organizing contents of the log file;
determining relevance of the log file contents and the stored data, the relevance based on parameters;
adjusting parameters by the master node;
sending the log file information and the data storage information to a preprocessor;
translating received data to match file types and the data file information association;
organizing, translated data;
transmitting translated data;
receiving, by a central processing node, translated data;
converting, by the central processing node, translated data into a final output data.
